(19) United States
(12) Patent Application Publication
(10) Pub. No.: US 2020/0167677 A1
(43) Pub. Date: May 28, 2020

(54) GENERATING RESULT EXPLANATIONS FOR NEURAL NETWORKS

(71) Applicant: International Business Machines Corporation, Armonk, NY (US)

(72) Inventors: Dinesh C. Verma, New Castle, NY (US); Seraphin Bernard Calo, Cortlandt Manor, NY (US); Supriyo Chakraborty, White Plains, NY (US)

(73) Assignee: International Business Machines Corporation, Armonk, NY (US)

(21) Appl. No.: 16/201,393

(22) Filed: Nov. 27, 2018

(51) Int. Cl. G06N 5/04; G06N 20/00; G06N 3/04; G06N 5/00

(52) U.S. Cl. CPC G06N 5/045; G06N 5/003; G06N 3/04; G06N 20/00

(57) ABSTRACT

A method includes training, using a first set of training data, to produce a machine learning model to generate an output based on an input. In an embodiment, the method includes training, using a second set of training data, to produce a second model to generate the output based on the input. In an embodiment, the method includes receiving a query to explain a decision-making process of the machine learning model. In an embodiment, the method includes producing, in response to the query, an explanation of the decision-making process of the second model.

### GOVERNMENT RIGHTS

This invention was made with Government support under W911NF-16-3-0001 awarded by Army Research Office. The Government has certain rights in this invention.

### TECHNICAL FIELD

The present invention relates generally to a method, system, and computer program product for providing explanations for machine learning based solutions. More particularly, the present invention relates to a method, system, and computer program product for explaining results that are provided by an artificial neural network.

### BACKGROUND

Machine learning (ML) algorithms build a model by learning patterns from a set of training data and are able to apply learned patterns to previously unseen data. For example, ML algorithms are able to solve complex tasks, such as automatic classification of images or sounds, by first learning patterns for classification from a set of training data, elements of the training data set including previously determined category labels.

Neural networks are one example of models built by ML algorithms. Neural networks are generally represented as distributed processing elements. For example, a neural network system can be implemented as a network of electronically coupled nodes, each node performing a specified function.

Another example of model can be built using step-by-step logic rules. For example, a decision tree is a series of branching nodes. At each node, a logic rule is applied to an input. For example, at a first node, the applied logic rule may determine whether a cat is depicted in an image.

A natural language is a written or a spoken language having a form that is employed by humans for primarily communicating with other humans or with systems having a natural language interface.

Natural language processing (NLP) is a technique that facilities exchange of information between humans and data processing systems. For example, one branch of NLP pertains to transforming human readable or human understandable content into machine usable data. For example, NLP engines are presently usable to accept input content such as human speech, and produce structured data, such as an outline of the input content, most significant and least significant parts, a subject, a reference, dependencies within the content, and the like, from the given content.

Hereinafter, a request for information presented in any correct or incorrect, complete or incomplete, colloquial or formal, grammatical form of a natural language, is interchangeably referred to as a “question” or “query” unless expressly disambiguated where used. The question or query are presented to the illustrative embodiment in a natural language.

### SUMMARY

The illustrative embodiments provide a method, system, and computer program product for generating result explanations for neural networks. An embodiment of the method includes training, using a first set of training data, to produce a machine learning model to generate an output based on an input. In an embodiment, the method includes training, using a second set of training data, to produce a second model to generate the output based on the input. In an embodiment, the method includes receiving a query to explain a decision-making process of the machine learning model. In an embodiment, the method includes producing, in response to the query, an explanation of the decision-making process of the second model.

In an embodiment, the first set of training data comprises a set of data elements, each element including a corresponding category label. In an embodiment, the method includes filtering the first set of training data to remove the corresponding category label from the set of data elements to produce a filtered set of training data. In an embodiment, the method includes generating, using the machine learning model, the second set of training data based on the filtered set of training data, the second set of training data comprising the set of data elements, each element including a generated category label.

In an embodiment, training to produce the second model further includes comparing a generated category label from the second set of training data to a category label from the first set of training data. In an embodiment, the method includes generating, in response to the generated category label differing from the category label, a new set of training data, the new set of training data comprising the generated category label and the corresponding data element. In an embodiment, the method includes re-training, in response to generating a new set of training data, the second model using the new set of training data.

In an embodiment, the machine learning model is a neural network. In an embodiment, the second model is a decision tree. In an embodiment, the method is embodied in a computer program product comprising one or more computer-readable storage devices and computer-readable program instructions which are stored on the one or more computer-readable tangible storage devices and executed by one or more processors.

An embodiment includes a computer usable program product. The computer usable program product includes a computer-readable storage device, and program instructions stored on the storage device.

In an embodiment, the computer usable code is stored in a computer readable storage device in a data processing system, and wherein the computer usable code is transferred over a network from a remote data processing system. In an embodiment, the computer usable code is stored in a computer readable storage device in a server data processing system, and wherein the computer usable code is downloaded over a network to a remote data processing system for use in a computer readable storage device associated with the remote data processing system

An embodiment includes a computer system. The computer system includes a processor, a computer-readable memory, and a computer-readable storage device, and program instructions stored on the storage device for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for generating result explanations for neural networks in accordance with an illustrative embodiment;

FIG. 4 depicts a flowchart of an example process for generating result explanations for neural networks in accordance with an illustrative embodiment;

FIG. 5 depicts a flowchart of an example process generating result explanations for neural networks in accordance with an illustrative embodiment; and

FIG. 6 depicts a flowchart of an example process generating result explanations for neural networks in accordance with an illustrative embodiment.

### DETAILED DESCRIPTION

The example devices and network infrastructures used or described herein are not intended to be limiting on the illustrative embodiments. From this disclosure, those of ordinary skill in the art will be able to adapt an embodiment for use with other types of network devices, in other types of network environments or infrastructures, and the same are contemplated within the scope of the illustrative embodiments.

The illustrative embodiments recognize that generally many machine learning algorithms do not provide information as to how and why the system reached a decision, and can be considered as unexplainable models. The illustrative embodiments recognize that understanding and interpreting decisions reached by machine learning algorithms provides additional information and allows for verification of the system. Some machine learning models provide explanations and can be defined as explainable models. Examples of unexplainable models are neural networks, deep neural networks, convolutional neural networks and hierarchical temporal memory. Examples of explainable models are decision trees, rule engines, and linear regression models.

The illustrative embodiments used to describe the invention generally address and solve the above-described problems and other problems related to explaining and interpreting machine learning algorithms. The illustrative embodiments provide a method, system, and computer program product for generating result explanation for neural networks.

An embodiment can be implemented as a software application. An embodiment generates result explanations for machine learning algorithms. In one embodiment, a set of training data including x input values is used to train an unexplainable model. For example, a neural network can be trained for multi-category classification. In an embodiment, the neural network is used to map an input such as sound clips to K categories, such as types of sounds. After training the unexplainable model, new input data is passed through the unexplainable model to classify the training data according to the K categories. For example, the neural network can classify sounds in the training data according to different sound types, including nonlimiting examples such as screams, thuds, and whispers.

In an embodiment, the neural network generates a new data set from the set of training data and the output category values. In an embodiment, a query is presented to an application implementing an embodiment. For example, a query can be presented to inquire why the neural network classified a particular input as a particular category. An embodiment generates K additional training sets, one for each of the K category values. In response to the query, the embodiment modifies an additional training set corresponding to the particular category by assigning a binary value to the particular category depending on whether the neural network classified the particular input as the particular category.

An embodiment trains an explainable model using the modified additional training set. For example, an embodiment can train a decision tree using the modified additional training set. An embodiment compares an output category value from the explainable model and an output category value from the unexplainable model for a particular input from the query. An embodiment returns a explanation derived from the explainable model in response to the output category values from the neural network.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description.

The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments.

Furthermore, a particular illustrative embodiment may have some, all, or none of the advantages listed above.

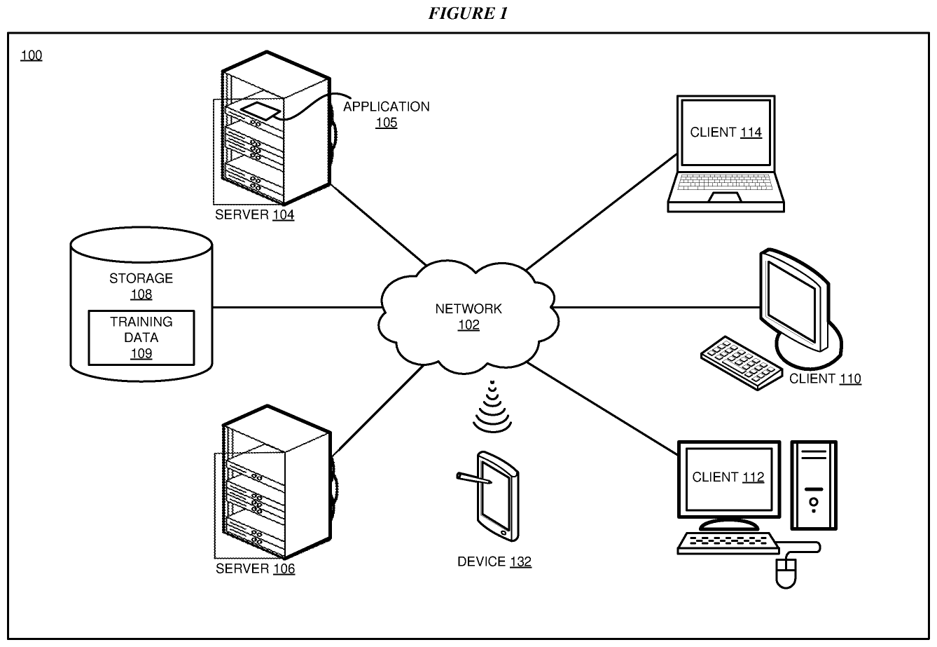

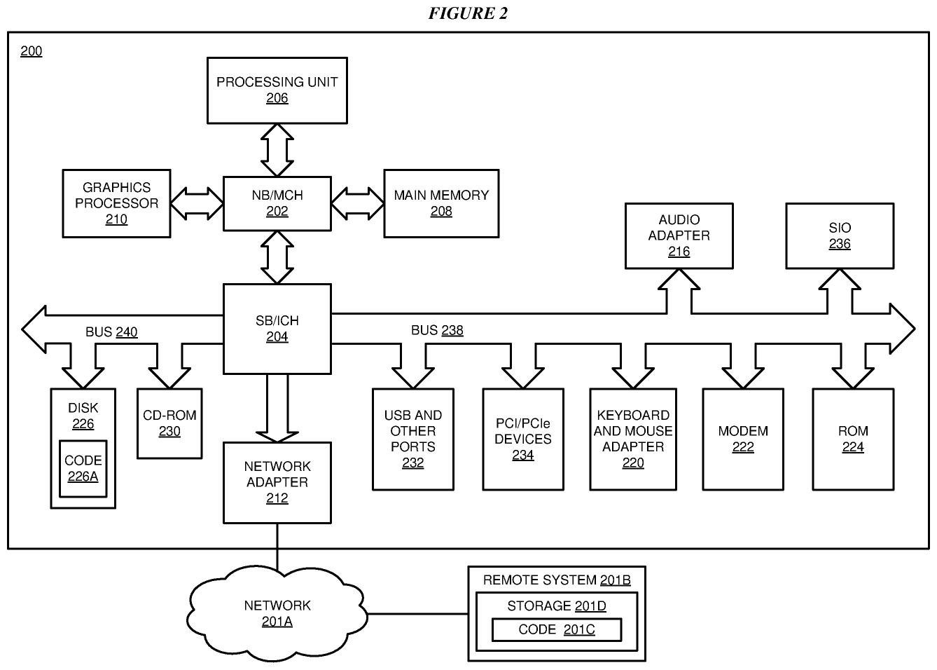

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a camera, a digital media player, a weather station, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 implements a remotely usable function (remote) of an embodiment described herein. Application 105 performs model training, data labelling, model comparison, query and response processing, other operations described herein, or some combination thereof.

Application 105 performs a result generation process for neural networks. Application 105 trains models using a set of training data, such as training data 109 in storage 108, filters the set of training data, labels (reclassifies) the set of training data using a trained model, compares the output of trained models, processes queries, and generates responses.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

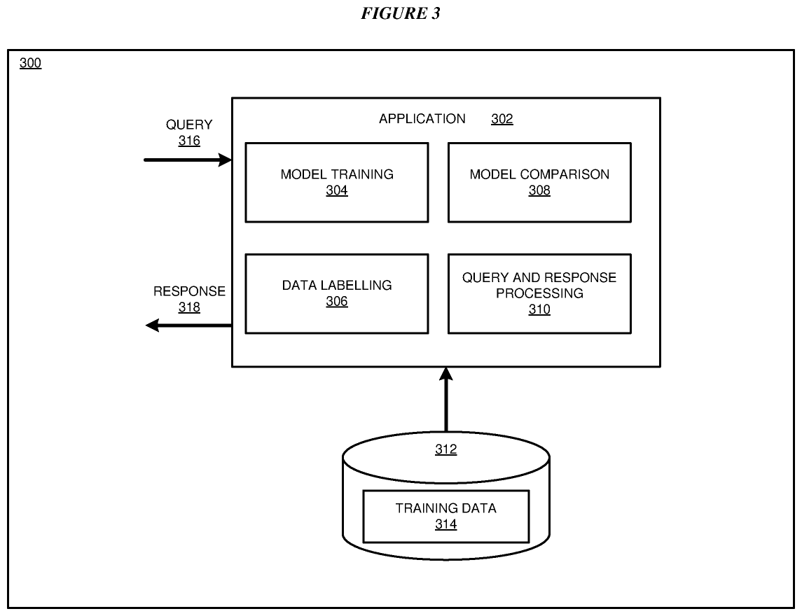

With reference to FIG. 3, this figure depicts a block diagram of an example configuration 300 for generating result explanations for neural networks. The example embodiment includes an application 302. In a particular embodiment, application 302 is an example of application 105 of FIG. 1.

Application 302 includes a model training component 304, a data labelling component 306, a model comparison component 308, and a query and response processing component 310. Component 304 uses a set of training data, such as training data 314 in storage 312, to train at least one model of a machine learning algorithm. In an embodiment, component 304 trains a model for multi-category classification. For example, training data 314 can include a set of images, each image having a corresponding category label. In an embodiment, component 304 maps the model to K categories. For example, training data 314 can be a set of n images of K different animals. One image in the set of images can depict a cat corresponding to a “cat image” category label. Another image can depict a shark corresponding to a “shark image” category label. In another embodiments, training data can be a set of sounds, one sound in the set corresponding to the sound of a screech, and other sound in the set corresponding to the sound of a thud.

In an embodiment, component 304 trains a simple model for multi-category classification with the set of training data 314. For example, component 314 can train a decision tree for multi-category classification. In another embodiment, component 304 trains a simple explainable model and a complex deep neural network model with the set of training data 314.

In an embodiment, component 306 filters the set of training data 314 to remove the associated category labels. In an embodiment, component 306 passes the filtered set of training data through the trained machine learning algorithm. For example, the trained machine learning algorithm generates category labels for the set of training data. In another embodiment, component 306 overwrites the previously associated category labels with the generated category labels using the trained machine learning algorithm.

Query 316 is a question asked regarding the machine learning algorithm output. For example, query 316 can include a question regarding why the machine learning algorithm generated a specific category label for a specific input of the set of training data. In an embodiment, component 310 performs any pre-processing, such as NLP, of query 316 received from a user.

In an embodiment, component 304 generates an additional K training data sets, each training data set corresponding to a specific category label. In response to the query 316, component 304 modifies an additional training set corresponding to the particular category in the query 316 by assigning a binary value to the particular category depending on whether the neural network classified the particular input in the query 316 as the particular category.

Component 304 trains an explainable model using the modified additional training set. For example, component 304 can train a decision tree using the modified additional training set. Component 308 compares an output category value from the explainable model and an output category value from the unexplainable model for a particular input from the query 316. Application 302 returns a response 318 in response to the output category values matching. Response 318 is an explanation of the explainable model. In an embodiment, component 310 performs any post-processing, such as NLP, of response 318.

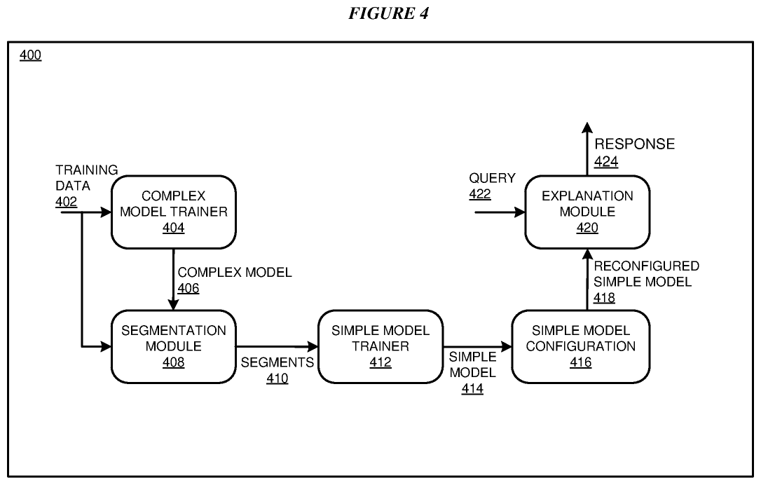

With reference to FIG. 4, this figure depicts a flowchart of an example process 400 for generating result explanations for neural networks in accordance with an illustrative embodiment. Process 400 can be implemented in application 105 within the scope of the illustrative embodiments.

In block 404, application 105 trains an unexplainable (complex) model 406 using a set of training data 402. In block 408, application 105 generates an additional K training data sets (segments 410), one for each category value in the set of training data. In block 412, application 105 trains a simple model using the additional K training data sets. For example, application 105 can train a simple model 414.

In block 416, application 105 configures the simple model. In an embodiment, application 105 configures the simple model to output an explanation to a decision-making process of the simple model. In an embodiment, application 105 can retrain the simple model to produce a reconfigured simple model 418. For example, application 105 can retrain the simple model to generate the same output as the complex model.

In block 420, application 105 receives a query 422. Application 105 performs processing on query 422. In block 420, application 105 outputs response 424 in response to the query 422. For example, application 105 outputs a decision-making process of the reconfigured simple model. Application 105 ends process 400 thereafter.

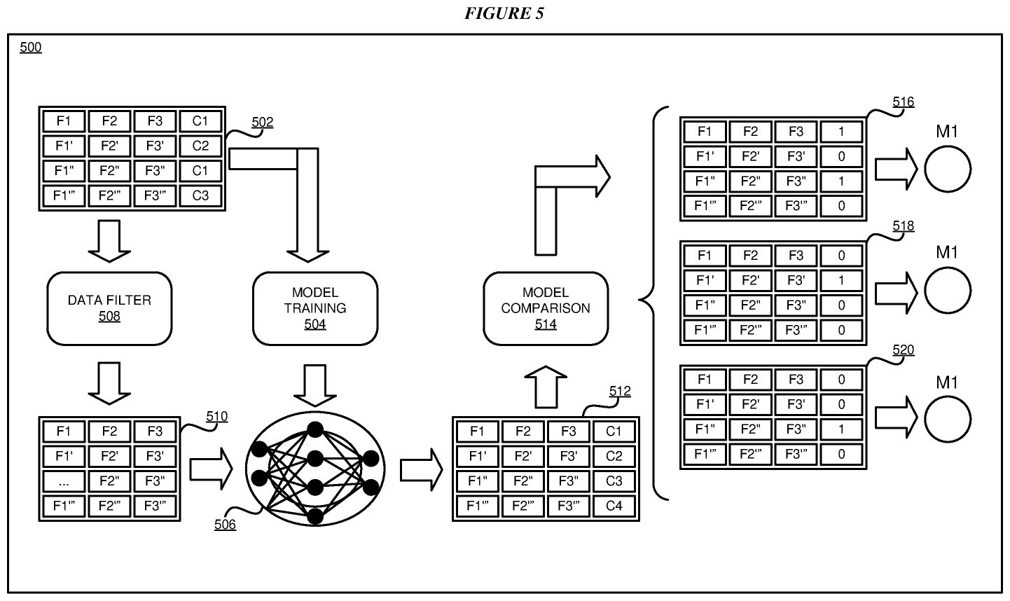

With reference to FIG. 5, this figure depicts a flowchart of an example process 500 for generating result explanations for neural networks in accordance with an illustrative embodiment. Process 500 can be implemented in application 105 within the scope of the illustrative embodiments.

In an embodiment, application 105 receives a set of training data 502. The set of training data 502 comprises a set of data elements and a set of associated category values. For example, the set of training data 502 comprises data elements F1, F2, and F3 with associated category value C1, data elements F1′, F2′, and F3′ with associated category value C2, data elements F1″, F2″, and F3″ with associated category value C1, etc. In block 504, application 105 trains a complex model using the set of training data. In block 508, application 105 removes the set of category labels from the set of training data to generate a set of filtered data. In an embodiment, complex model 506 generates a set of category labels for the set of filtered data. For example, complex model 506 can generate associated category value C1 with data elements F1, F2, and F3, associated category value C2 with data elements F1′, F2′, F3′, etc. In an embodiment, the associated category labels in generated data set 512 differ from the associated category labels in the training data set 502.

In an embodiment, application 105 receives a query. For example, application 105 can receive a query regarding an explanation for why the complex model classified a particular input according to a particular category label. In an embodiment, application 105 creates a plurality of additional training data sets, one data set for each category label. In an embodiment, application 105 modifies an output label of the generated data set 512. For example, application 105 can modify the output label to a binary value (1 or 0) in response to determining whether the complex model associated the particular category label with the particular input in the query. In an embodiment, application 105 trains an explainable model using the modified data sets 516, 518, 520. In block 514, application 105 compares the generated category labels from the complex model to an output of the explainable model. In an embodiment, application 105 outputs a decision making process of the explainable model in response to the query. For example, application 105 can output the decision making process in response to determining a generated category label of the complex model matches a generated category label of the explainable model. Application 105 ends process 500 thereafter.

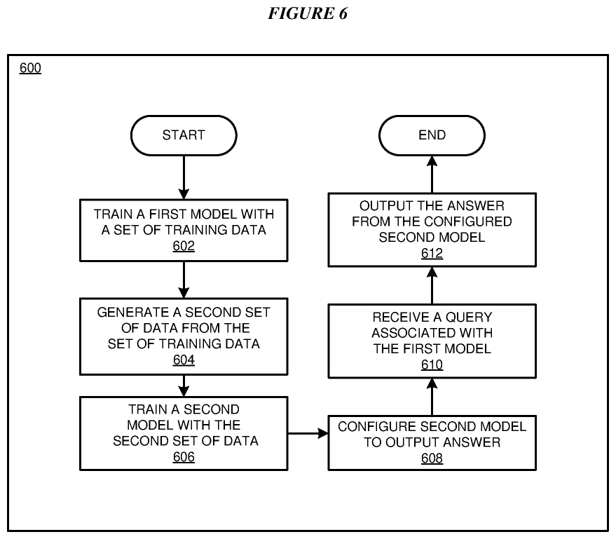

With reference to FIG. 6, this figure depicts a flowchart of an example process 600 for generating result explanation for neural networks in accordance with an illustrative embodiment. Process 600 can be implemented in application 105 within the scope of the illustrative embodiments.

In block 602, application 105 trains a first model with a first set of training data. For example, application 105 can train a machine learning model. In block 604, application 105 generates a second set of data from the set of training data. For example, application 105 can input the first set of training data into the trained machine learning model. In an embodiment, the trained machine learning model outputs a set of category labels for each data element of the first set of training data.

In block 606, application 105 trains a second model with the second set of data. For example, application 105 can train a second model, such as a decision tree. In block 608, application 105 configures the second model to output a response (answer). For example, the second model can be configured to output an explanation of a decision-making process of the second model.

In block 610, application 105 receives a query associated with the first model. In an embodiment, application 105 parses the query and performs processing on the query with NLP. In block 612, application 105 outputs the explanation of the decision-making process of the second model in response to receiving the query. Application 105 ends process 600 thereafter. In an embodiment, the query associated with the first model can be “Why did the neural network classify this sound as a female voice and not a male voice”, and the explanation derived from a decision tree model can be “For sounds in a street environment, when a dominant frequency exceeds 150 Hz, it classifies as female voice, and when it is less, it is classified as male voice”. In another embodiment, the query could be “Why is this sound classified as beep, and not as a thud,” and the explanation derived from a clustering model can be —“Because this sound is very close to another sample, which was labeled as a beep in the training data—please click here to play the two sounds.”.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
training, using a first set of training data, to produce a machine learning model to generate an output based on an input;
training, using a second set of training data, to produce a second model to generate the output based on the input;
receiving a query to explain a decision-making process of the machine learning model; and
producing, in response to the query, an explanation of the decision-making process of the second model.

2. The method of claim 1, wherein the first set of training data comprises a set of data elements, each element including a corresponding category label.

3. The method of claim 2, further comprising:
filtering the first set of training data to remove the corresponding category label from the set of data elements to produce a filtered set of training data.

4. The method of claim 3, further comprising:
generating, using the machine learning model, the second set of training data based on the filtered set of training data, the second set of training data comprising the set of data elements, each element including a generated category label.

5. The method of claim 4, training to produce the second model further comprising:
comparing a generated category label from the second set of training data to a category label from the first set of training data.

6. The method of claim 5, further comprising:
generating, in response to the generated category label differing from the category label, a new set of training data, the new set of training data comprising the generated category label and the corresponding data element; and
re-training, in response to generating a new set of training data, the second model using the new set of training data.

7. The method of claim 1, wherein the machine learning model is a neural network.

8. The method of claim 1, wherein the second model is a decision tree.

9. The method of claim 1, wherein the method is embodied in a computer program product comprising one or more computer-readable storage devices and computer-readable program instructions which are stored on the one or more computer-readable tangible storage devices and executed by one or more processors.

10. A computer usable program product for generating result explanations for neural networks, the computer program product comprising a computer-readable storage device, and program instructions stored on the storage device, the stored program instructions comprising:
program instructions to train, using a first set of training data, to produce a machine learning model to generate an output based on an input;
program instructions to train, using a second set of training data, to produce a second model to generate the output based on the input;
program instructions to receive a query to explain a decision-making process of the machine learning model; and
program instructions to produce, in response to the query, an explanation of the decision-making process of the second model.

11. The computer usable program product of claim 10, wherein the first set of training data comprises a set of data elements, each element including a corresponding category label.

12. The computer usable program product of claim 11, the stored program instructions further comprising:
program instructions to filter the first set of training data to remove the corresponding category label from the set of data elements to produce a filtered set of training data.

13. The computer usable program product of claim 12, the stored program instructions further comprising:
program instructions to generate, using the machine learning model, the second set of training data based on the filtered set of training data, the second set of training data comprising the set of data elements, each element including a generated category label.

14. The computer usable program product of claim 13, the stored program instructions further comprising:
program instructions to compare a generated category label from the second set of training data to a category label from the first set of training data.

15. The computer usable program product of claim 14, the stored program instructions further comprising:
program instructions to generate, in response to the generated category label differing from the category label, a new set of training data, the new set of training data comprising the generated category label and the corresponding data element; and
program instructions to re-train, in response to generating a new set of training data, the second model using the new set of training data.

16. The computer usable program product of claim 10, wherein the machine learning model is a neural network.

17. The computer usable program product of claim 10, wherein the second model is a decision tree.

18. The computer usable program product of claim 10, wherein the computer usable code is stored in a computer readable storage device in a data processing system, and wherein the computer usable code is transferred over a network from a remote data processing system.

19. The computer usable program product of claim 10, wherein the computer usable code is stored in a computer readable storage device in a server data processing system, and wherein the computer usable code is downloaded over a network to a remote data processing system for use in a computer readable storage device associated with the remote data processing system.

20. A computer system for generating result explanations for neural networks, the computer system comprising a processor, a computer-readable memory, and a computer-readable storage device, and program instructions stored on the storage device for execution by the processor via the memory, the stored program instructions comprising:
program instructions to train, using a first set of training data, to produce a machine learning model to generate an output based on an input;
program instructions to train, using a second set of training data, to produce a second model to generate the output based on the input;
program instructions to receive a query to explain a decision-making process of the machine learning model; and
program instructions to produce, in response to the query, an explanation of the decision-making process of the second model.
